(19) United States
(12) Patent Application Publication
(10) Pub. No.: US 2021/0219572 A1
(43) Pub. Date: Jul. 22, 2021

(54) ANTLER SAVER RODENT CHEWS

(71) Applicants: Cody Herring, White City, OR (US); Casey Marshall, Central Point, OR (US)

(72) Inventors: Cody Herring, White City, OR (US); Casey Marshall, Central Point, OR (US)

(21) Appl. No.: 16/746,830

(22) Filed: Jan. 18, 2020

(51) Int. Cl. A23K 10/40; A23K 50/50

(52) U.S. Cl. CPC A23K 10/40; A23K 50/50

(57) ABSTRACT

A method for preventing rodents from damaging shed antlers is disclosed. The method includes the steps of: creating a mineral block constructed to be placed in a wintering grounds of antlered deer prior to antler cast-off, the mineral block containing at least phosphorus and calcium salts; mixing at least a powdered phosphorus salt and a powdered calcium salt to create a salt mixture; combining the salt mixture with a powdered mortar; adding water to the salt mixture and powdered mortar to produce a wet mortar; placing the wet mortar in a mold and allowing it to dry to form the mineral block; and, removing the mold from formed mineral block. The resulting product may then be distributed as necessary in a specified area where antler cast-offs are present.

### FIELD OF THE INVENTION

This invention relates to edible supplements for land animals. More particularly, it relates to mineral attractants for rodents or other land animals.

### BACKGROUND

Members of the deer family shed their antlers on an annual basis. This is in contrast to animals such as sheep, cattle, bison and the like, which keep their horns year after year. As some of these “shed antlers” from deer can become quite large, they are often used as a decorative element. “Shed hunters”, as they are called, collect these antlers for sale. Unfortunately, rodents, such as squirrels, mice, porcupines, and the like also value them for their calcium and other minerals which are missing in their diet. This chewing, eating and gnawing on the shed antlers greatly reduces their value. While the ability to improve hunting techniques to quickly find these shed antlers before the rodents is limited, the ability to provide dietary mineral supplements so the rodents are less likely to chew upon the antlers is not. Accordingly, there exists a need for a means by which mineral supplements can be provided to rodents to reduce the likelihood of damage to shed antlers.

### BRIEF DESCRIPTION OF THE DRAWINGS

FIG. 1 is a flow diagram illustrating a method for preventing rodents from damaging shed antlers.

FIG. 2 is another flow diagram illustrating a method for preventing rodents from damaging shed antlers.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

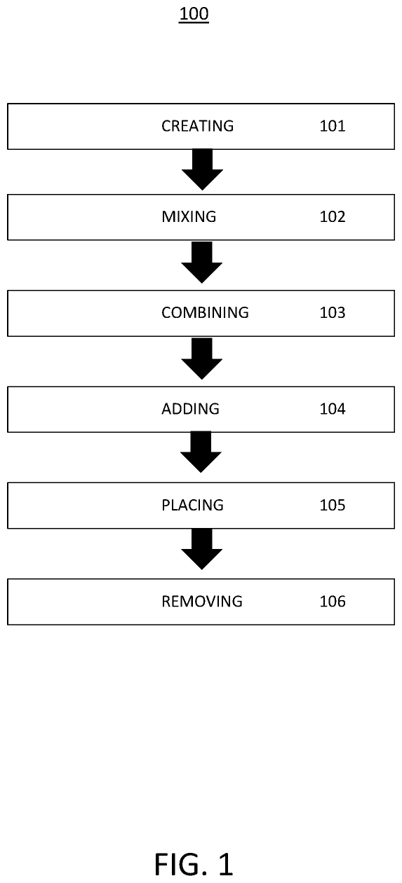

Referring to FIG. 1, a flow diagram illustrating a method 100 for preventing rodents from damaging shed antlers. The method 100 may include the steps of: step one, creating 101 a mineral block constructed to be placed in a wintering grounds of antlered deer prior to antler cast-off, the mineral block containing at least phosphorus and calcium salts; step two, mixing 102 at least a powdered phosphorus salt and a powdered calcium salt to create a salt mixture; step three, combining 103 the salt mixture with a powdered mortar; step four, adding 104 water to the salt mixture and powdered mortar to produce a wet mortar; step five, placing 105 the wet mortar in a mold and allowing it to dry to form the mineral block; and step six, removing 106 the mold from formed mineral block. The resulting product may then be distributed as necessary in a specified area where antler cast-offs may be present.

In some embodiments, the salt mixture may also contain sulfur and a magnesium salt. A preferred embodiment may call for the salt mixture to comprise approximately 0.08 grams of phosphorus salt (equaling approximately 3.96% by weight), approximately 0.02 grams of sulfur (equaling approximately 0.99% by weight), approximately 1.84 grams of calcium salt (equaling approximately 91.09% by weight), and approximately 0.08 grams of magnesium salt (equaling approximately 3.96% by weight). The resulting mortar may be formed as Plaster of Paris in the amount of at least 4 ounces. Exact dimensions may vary, but a preferred embodiment may include a rectangular mineral block of approximately 15 cubic inches and has a length of approximately 5 inches, width of approximately 3 inches and height of approximately 1 inch.

In another embodiment, the mineral block may be created in a continuous batch process and include calcium salt formulated as calcium carbonate. The method 100 may include a mineral block for preventing rodents from damaging cast-off deer antlers comprising a mixture of a calcium salt, a phosphorus salt and a mortar formed into a sold block by forming in a mold. The mineral block may further comprise magnesium salt and sulfur. The mineral block may alternatively comprise approximately 0.08 grams of phosphorus salt, approximately 0.02 grams of sulfur, approximately 1.84 grams of calcium salt, approximately 0.08 grams of magnesium salt, and approximately 4 ounces of mortar.

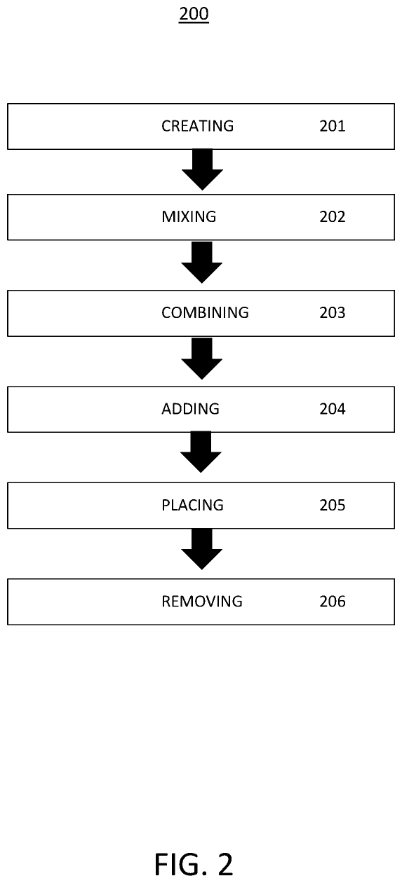

Moving now to FIG. 2, a flow diagram illustrating a method 200 for preventing rodents from damaging shed antlers. The method 200 may include the steps of: step one, creating 201 a mineral block constructed to be placed in a wintering grounds of antlered deer prior to antler cast-off, the mineral block containing at least phosphorus and calcium salts; step two, mixing 102 approximately 0.08 grams of phosphorus salt, approximately 0.02 grams of sulfur, approximately 1.84 grams of calcium salt, and approximately 0.08 grams of magnesium salt to create a salt mixture; step three, combining 103 the salt mixture with a powdered mortar; step four, adding 104 water to the salt mixture and powdered mortar to produce a wet mortar; step five, placing 105 the wet mortar in a mold and allowing it to dry to form the mineral block; and step six, removing 106 the mold from formed mineral block. The resulting product may then be distributed as necessary in a specified area where antler cast-offs may be present.

In a preferred embodiment, the resulting mortar may be formed as Plaster of Paris in the amount of at least 4 ounces. Exact dimensions may vary, but the process may produce a rectangular mineral block of approximately 15 cubic inches and has a length of approximately 5 inches, width of approximately 3 inches and height of approximately 1 inch. Here again, the mineral block may be created in a continuous batch process. In all embodiments, the disclosed methods and products of those methods may act to serve as a replacement for shed antlers, which may be removed from the ecosystem.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for preventing rodents from damaging cast-off deer antlers comprising:
creating a mineral block constructed to be placed in a wintering grounds of antlered deer prior to antler cast-off, the mineral block containing at least phosphorus and calcium salts;
the block created by:
(a) mixing at least a powdered phosphorus salt and a powdered calcium salt to create a salt mixture;
(b) combining the salt mixture with a powdered mortar;
(c) subsequently adding water to the salt mixture and powdered mortar to produce a wet mortar;
(d) placing the wet mortar in a mold and allowing it to dry to form the mineral block;
(e) removing the mold from formed mineral block.

2. The method of claim 1 wherein the salt mixture also contains sulfur and a magnesium salt.

3. The method of claim 2 wherein the salt mixture comprises:
(a) approximately 0.08 grams of phosphorus salt;
(b) approximately 0.02 grams of sulfur;
(c) approximately 1.84 grams of calcium salt;
(d) approximately 0.08 grams of magnesium salt.

4. The method of claim 3 wherein the mortar is Plaster of Paris.

5. The method of claim 4 comprising approximately 4 ounces of Plaster of Paris.

6. The method of claim 5 wherein the mineral block is a rectangular solid and has length of approximately 5 inches, width of approximately 3 inches and height of approximately 1 inch.

7. The method of claim 5 wherein the mineral block has a volume of approximately 15 cubic inches.

8. The method of claim 2 wherein the salt mixture comprises by weight:
(a) approximately 3.96% phosphorus salt;
(b) approximately 0.99% sulfur;
(c) approximately 91.09% calcium salt;
(d) approximately 3.96% magnesium salt.

9. The method of claim 1 wherein mineral blocks are created in a continuous batch process.

10. The method of claim 1 wherein the calcium salt is calcium carbonate.

11. A mineral block for preventing rodents from damaging cast-off deer antlers comprising a mixture of a calcium salt, a phosphorus salt and a mortar formed into a sold block by forming in a mold.

12. The mineral block of claim 11 further comprising a magnesium salt and sulfur.

13. The mineral block of claim 12 wherein the block comprises:
(a) approximately 0.08 grams of phosphorus salt;
(b) approximately 0.02 grams of sulfur;
(c) approximately 1.84 grams of calcium salt;
(d) approximately 0.08 grams of magnesium salt;
(e) approximately 4 ounces of mortar.

14. The mineral block of claim 13 wherein the mortar is Plaster of Paris.

15. The mineral block of claim 11 wherein the block is a rectangular solid having a length of approximately 5 inches, a width of approximately 3 inches and a height of approximately 1 inch.

16. A method for preventing rodents from damaging cast-off deer antlers comprising:
creating a mineral block constructed to be placed in a wintering grounds of antlered deer prior to antler cast-off, the mineral block containing at least phosphorus and calcium salts;
the block created by:
(a) mixing:
(i) approximately 0.08 grams of phosphorus salt;
(ii) approximately 0.02 grams of sulfur;
(iii) approximately 1.84 grams of calcium salt;
(iv) approximately 0.08 grams of magnesium salt. to create a salt mixture;
(b) combining the salt mixture with a powdered mortar;
(c) subsequently adding water to the salt mixture and powdered mortar to produce a wet mortar;
(d) placing the wet mortar in a mold and allowing it to dry to form the mineral block;
(e) removing the mold from formed mineral block.

17. The method of claim 16 wherein the mortar is Plaster of Paris.

18. The method of claim 17 comprising approximately 4 ounces of Plaster of Paris.

19. The method of claim 16 wherein the mineral block is a rectangular solid and has length of approximately 5 inches, width of approximately 3 inches and height of approximately 1 inch.

20. The method of claim 16 wherein mineral blocks are created in a continuous batch process.
